(19) United States
(12) Patent Application Publication
(10) Pub. No.: US 2019/0105650 A1
(43) Pub. Date: Apr. 11, 2019

(54) CATALYST HAVING SCR-ACTIVE COATING

(71) Applicant: UMICORE AG & CO. KG, Hanau-Wolfgang (DE)

(72) Inventors: Frank WELSCH, Rodenbach (DE); Stephan ECKHOFF, Alzenau (DE); Michael SEYLER, Mainaschaff (DE); Anke SCHULER, Niedernberg (DE)

(73) Assignee: UMICORE AG & CO. KG, Hanau-Wolfgang (DE)

(21) Appl. No.: 16/086,720

(22) PCT Filed: Apr. 13, 2017
(86) PCT No.: PCT/EP2017/058900

§ 371 Date: Sep. 20, 2018

(30) Foreign Application Priority Data
Apr. 13, 2016 (EP) 16165078.3

(51) Int. Cl. B01J 35/00; B01J 29/76; B01J 29/80; B01J 37/02; B01D 53/94

(52) U.S. Cl. CPC B01J 35/0006; B01J 29/763; B01J 29/80; B01J 37/0246; B01D 53/9418; B01D 2255/9205; B01D 2255/1021; B01D 2255/20738; B01D 2255/20761; B01D 2255/50; B01D 2255/9032; B01D 2251/2062

(57) ABSTRACT

The invention relates to a catalyst, which comprises a catalyst substrate of the length L and two SCR-catalytically active materials A and B, wherein the SCR-catalytically active material A contains a zeolite of the levyne structure type, which contains ion-exchanged iron and/or copper, and the SCR-catalytically active material B contains a zeolite of the chabazite structure type, which contains ion-exchanged iron and/or copper, wherein (i) the SCR-catalytically active materials A and B are in the form of two material zones A and B, wherein material zone A extends from the first end of the catalyst substrate at least over part of the length L and material zone B extends from the second end of the catalyst substrate at least over part of the length L, or wherein (ii) the catalyst substrate is formed by the SCR-catalytically active material A or B and a matrix component and the SCR-catalytically active material B or A extends at least over part of the length L of the catalyst substrate in the form of a material zone B or A.

The present invention relates to a catalyst with an SCR-active coating for reducing nitrogen oxides in the exhaust gas of internal combustion engines.

Exhaust gases from motor vehicles with a predominantly lean-operated internal combustion engine contain in particular the primary emissions carbon monoxide (CO) hydrocarbons (HC) and nitrogen oxides (NOx) in addition to particle emissions. Due to the relatively high oxygen content of up to 15% by volume, carbon monoxide and hydrocarbons can be rendered harmless relatively easily by oxidation. The reduction of nitrogen oxides into nitrogen is however much more difficult.

A known method for removing nitrogen oxides from exhaust gases in the presence of oxygen is selective catalytic reduction (SCR method) by means of ammonia on a suitable catalyst. In this method, the nitrogen oxides to be removed from the exhaust gas are converted to nitrogen and water using ammonia.

The ammonia used as a reduction agent can be made available by dosing an ammonia precursor compound, such as urea, ammonium carbamate or ammonium formate, into the exhaust system and subsequent hydrolysis.

Particles can be very effectively removed from the exhaust gas with the assistance of particle filters. Wall flow filters made of ceramic materials have been particularly successful. They are constructed from a plurality of parallel channels which are formed by porous walls. The channels are alternatingly sealed in a gas-tight manner on one of the two ends of the filter so that first channels are formed which are open on the first side of the filter and closed on the second side of the filter as well as second channels which are closed on the first side of the filter and open on the second side of the filter. The exhaust gas that, for example, flows into the first channels can only leave the filter via the second channels and must flow through the porous walls between the first and second channels to do so. The particles are retained when the exhaust gas passes through the wall.

It is also already known to coat wall flow filters with SCR-active material and thus simultaneously remove particles and nitrogen oxides from the exhaust gas. Such products are normally termed SDPF.

To the extent that the required amount of SCR-active material is applied to the porous walls between the channels (so-called on-wall coating), this however can lead to an unacceptable increase of the counter-pressure in the filter.

Against this background, JPH01-151706 and WO2005/016497, for example, propose coating a wall flow filter with an SCR catalyst such that the latter penetrates the porous walls (so-called in-wall coating).

It has also been proposed (see US 2011/274601) to introduce a first SCR catalyst into the porous wall, i.e., to coat the inner surfaces of the pores, and to place a second SCR catalyst on the surface of the porous wall. The average particle size of the first SCR catalyst is in this case less than that of the second SCR catalyst.

Moreover, it has been proposed in WO2013/014467 A1 to arrange two or more SCR-active zones successively on a particle filter. The zones can contain the same SCR-active material in different concentrations or different SCR-active materials. In any case, the more thermally stable SCR-active material is preferably arranged at the filter inlet.

Particle filters must be regenerated at certain time intervals, i.e., the collected soot particles must be burned off in order to keep the exhaust gas counter-pressure within an acceptable range. To regenerate the filter and initiate soot combustion, exhaust gas temperatures of approximately 600° C. are needed. During combustion, very high temperatures, which can be >800° C., can occur.

Nowadays common NH₃—SCR catalysts can lead to the formation of nitrous oxide (N₂O) by way of an undesired side reaction. This holds true also for combinations of particle filters and NH₃ SCR catalysts, for example, in filter regeneration. Since N₂O is a known greenhouse gas, its formation should be prevented as much as possible.

WO2015/145113 discloses a method for reducing N₂O emissions in exhaust gas that is characterized in that a small-pore zeolite with an SAR of approximately 3 to approximately 15 is used which comprises approximately 1 to 5% by weight of an exchanged transition metal.

There is still a need for NH₃ SCR catalysts and in particular for combinations consisting of particle filters and NH₃ SCR catalysts that form as little N₂O as possible.

It was surprisingly found that catalysts that are provided with an SCR function and form less N₂O are obtained when different zeolite structure types, i.e., those of the CHA and LEV structure types, are arranged in a specific manner on the catalyst.

The present invention relates to a catalyst that comprises a catalyst substrate of length L and two SCR-catalytically active materials A and B that differ from each other,

wherein the SCR-catalytically active material A comprises a zeolite of the levyne structure type that contains ion-exchanged iron and/or copper, and the SCR-catalytically active material B comprises a zeolite of the chabazite structure type that contains ion-exchanged iron and/or copper, wherein

(i) the SCR-catalytically active materials A and B are present in the form of two material zones A and B, wherein material zone A proceeding from the first end of the catalyst substrate extends at least over a part of the length L and material zone B proceeding from the second end of the catalyst substrate extends at least over part of the length L,

or wherein

(ii) the catalyst substrate is formed from the SCR-catalytically active material A and a matrix component, and the SCR-catalytically active material B extends in the form of a material zone B at least over part of the length L of the catalyst substrate,

or wherein

(iii) the catalyst substrate is formed from the SCR-catalytically active material B and a matrix component, and the SCR-catalytically active material A extends in the form of a material zone A at least over part of the length L of the catalyst substrate.

In embodiments of the present invention, the zeolite of the chabazite structure type has an SAR value (ratio of silicon dioxide to aluminum oxide) of 6 to 40, preferably 12 to 40, and particularly preferably 25 to 40.

In embodiments of the present invention, the zeolite of the levyne structure type has an SAR value greater than 15, preferably greater than 30, such as 30 to 50.

Possible zeolites of the chabazite structure type are, for example, those products known under the name of chabazite and SSZ-13. Possible zeolites of the levyne structure type are, for example, Nu-3, ZK-20 and LZ-132.

Within the scope of the present invention, not only aluminosilicates but also silicoaluminophosphates and aluminophosphates, which are occasionally also termed zeolite-like compounds, also fall under the term “zeolite.” Examples are in particular SAPO-34 and AIPO-34 (structure type CHA) and SAPO-35 and AIPO-35 (structure type LEV).

In embodiments of the present invention, both the zeolite of the chabazite structure type as well as the zeolite of the levyne structure type contain ion-exchanged copper.

The amounts of copper in the zeolite of the chabazite structure type and in the zeolite of the levyne structure type are independently of each other in particular 0.2 to 6% by weight, preferably 1 to 5% by weight, calculated as CuO and in relation to the overall weight of the exchanged zeolite. The atomic ratios of swapped copper in the zeolites to the lattice aluminum in the zeolite, hereinafter termed the Cu/Al ratios, in the zeolite of the chabazite structure type and in the zeolite of the levyne structure type are independently of each other in particular 0.25 to 0.6.

This corresponds to a theoretical exchange level of copper with the zeolite of 50 to 120% starting from a complete charge balance in the zeolite by bivalent Cu ions at an exchange level of 100%. Cu/Al values of 0.35-0.5, which corresponds to a theoretical copper exchange level of 70-100%, are particularly preferable.

To the extent that the employed zeolites contain ion-exchanged iron, the amounts of iron in the zeolite of the chabazite structure type and in the zeolite of the levyne structure type are independently of each other in particular 0.5 to 10% by weight, preferably 1 to 5% by weight, calculated as Fe₂O₃ and in relation to the overall weight of the exchanged zeolite.

The atomic ratios of swapped iron in the zeolites to the lattice aluminum in the zeolite, hereinafter termed the Fe/Al ratios, in the zeolite of the chabazite structure type and in the zeolite of the levyne structure type are independently of each other in particular 0.25 to 3. Fe/Al values of 0.4 to 1.5 are particularly preferable.

The material zone A comprises, for example, no catalytically active components except for the zeolites of the levyne structure type exchanged with copper or iron. However, it may, where applicable, contain additives, such as binders. Suitable binders are, for example, aluminum oxide, titanium oxide and zirconium oxide, wherein aluminum oxide is preferred. In embodiments of the present invention, material zone A consists of zeolites of the levyne structure type exchanged with copper or iron, as well as of binders. Aluminum oxide is preferred as the binder.

The material zone B also comprises, for example, no catalytically active components except for the zeolites of the chabazite structure type exchanged with copper or iron. However, it may, where applicable, contain additives, such as binders. Suitable binders are, for example, aluminum oxide, titanium oxide and zirconium oxide. In embodiments of the present invention, material zone A consists of zeolites of the chabazite structure type exchanged with copper or iron, as well as of binders. Aluminum oxide is preferred as the binder.

In embodiments of the present invention, 20 to 80% by weight of the catalytically active material is in material zone B, preferably 40 to 80% by weight, particularly preferably 50 to 70% by weight.

In a preferred embodiment, the present invention relates to a catalyst that comprises a catalyst substrate of length L and two SCR-catalytically active materials A and B that are different from each other, wherein the SCR-catalytically active material A comprises a zeolite of the levyne structure type that contains ion-exchanged iron and/or copper, and the SCR-catalytically active material B contains a zeolite of the chabazite structure type that contains iron-exchanged iron and/or copper, wherein

the SCR-catalytically active materials A and B are present in the form of two material zones A and B, wherein material zone A proceeding from the first end of the catalyst substrate extends at least over a part of the length L and material zone B proceeding from the second end of the catalyst substrate extends at least over part of the length L.

In this embodiment, the exhaust gas preferably flows into the catalyst at the first end of the catalyst substrate and out of the catalyst at the second end of the catalyst substrate.

In this embodiment, the two material zones A and B can furthermore be arranged in different ways on the catalyst substrate, wherein so-called flow-through substrates or wall flow filters can be used as catalyst substrates.

A wall flow filter is a catalyst substrate that comprises channels of length L which extend parallelly between a first and second end of the wall flow filter, which are alternatingly sealed in a gas-tight manner either at the first or second end, and which are separated by porous walls. A flow-through substrate differs from a wall flow filter in particular in that the channels of length L are open at its two ends.

In the following embodiments of the present invention, the catalyst substrate can be a wall flow filter or a flow-through substrate.

In a first embodiment, the material zone A extends over the entire length L of the catalyst substrate, whereas material zone B proceeding from the second end of the catalyst substrate extends over 10 to 80% of its length L. In this case, material zone B is preferably arranged on material zone A.

In a second embodiment, material zone A proceeding from the first end of the catalyst substrate extends over 20 to 90% of its length L, whereas material zone B proceeding from the second end extends over 10 to 70% of its length L. To the extent that the material zones A and B overlap in this embodiment, material zone A is preferably arranged on material zone B. In a third embodiment, material zone A proceeding from the first end of the catalyst substrate extends over 20 to 100% of its length L, whereas material zone B extends over its entire length L. In this case, material zone A is preferably arranged on material zone B.

In another embodiment of the catalyst according to the invention, the catalyst substrate is designed as a wall flow filter. The channels that are open at the first end of the wall flow filter and closed at the second end are coated with material zone A, whereas the channels that are closed at the first end of the wall flow filter and open at the second end are coated with material zone B.

The flow-through substrates and wall flow filters that can be used according to the present invention are known and obtainable on the market. They consist, for example, of silicon carbide, aluminum titanate or cordierite.

In an uncoated state, wall flow filters have porosities of 30 to 80, in particular 50 to 75%, for example. Their average pore size in an uncoated state is, for example, 5 to 30 μm.

Generally, the pores of the wall flow filter are so-called open pores, that is, they have a connection to the channels. In addition, the pores are generally connected to each other. On the one hand, this enables easy coating of the inner pore surfaces and, on the other hand, easy passage of the exhaust gas through the porous walls of the wall flow filter.

The catalyst according to the invention can be produced according to methods familiar to the person skilled in the art, e.g., according to the common dip coating method or pump coating and suction coating methods with subsequent thermal aftertreatment (calcination). A person skilled in the art knows that in the case of wall flow filters, their average pore size and the average particle size of the SCR-catalytically active materials can be adapted to each other such that the material zones A and/or B lie on the porous walls that form the channels of the wall flow filter (on-wall coating). Preferably, however, the average particle sizes of the SCR-catalytically active materials are selected such that both material zone A and material zone B are located in the porous walls that form the channels of the wall flow filter so that the inner pore surfaces are coated (in-wall coating). In this case, the average particle size of the SCR-catalytically active materials must be small enough to penetrate into the pores of the wall flow fitter.

However, the present invention also comprises embodiments in which one of the material zones A and B is coated in-wall, and the other is coated on-wall.

The present invention also relates to embodiments in which the catalyst substrate is formed from an inert matrix component and the SCR-catalytically active material A or B and the other SCR-catalytically active material, i.e., material B or A, extends in the form of a material zone B or A over at least part of the length L of the catalyst substrate.

Catalyst substrates, flow-through substrates and wall flow substrates that do not just consist of inert material, such as cordierite, but additionally contain a catalytically active material are known to the person skilled in the art. To produce them, a mixture consisting of, for example, 10 to 95% by weight of an inert matrix component and 5 to 90% by weight of catalytically active material is extruded according to a method known per se. All of the inert materials that are also otherwise used to produce catalyst substrates can be used as matrix components in this case. These matrix components are, for example, silicates, oxides, nitrides or carbides, wherein in particular magnesium aluminum silicates are preferred.

The extruded catalyst substrates that comprise SCR-catalytically active material A or B can also be coated according to common methods like inert catalyst substrates.

Accordingly, a catalyst substrate that comprises SCR-catalytically active material B can, for example, be coated over its entire length or a part thereof with a wash coat that contains the SCR-catalytically active material A.

Likewise, a catalyst substrate that comprises SCR-catalytically active material A can, for example, be coated over its entire length or a part thereof with a wash coat that contains the SCR-catalytically active material B.

The catalysts according to the invention with SCR-active coating can advantageously be used to purify exhaust gas from lean-operated internal combustion engines, in particular diesel engines. In this case, they are to be arranged in the exhaust gas stream such that material zone A comes into contact with the exhaust gas to be purified before material zone B. Nitrogen oxides contained in the exhaust gas are in this case converted into the harmless compounds nitrogen and water.

The present invention accordingly also relates to a method for purifying exhaust gas from lean-operated internal combustion engines, characterized in that the exhaust gas is conducted over a catalyst according to the invention, wherein material zone A comes into contact with the exhaust gas to be purified before material zone B.

Ammonia is preferably used as the reducing agent in the method according to the invention. The required ammonia can, for example, be formed in the exhaust gas system upstream of the catalyst according to the invention, e.g., by means of an upstream nitrogen oxide trap catalyst (lean NOx trap—LNT). This method is known as “passive SCR.”

Ammonia can however also be entrained on board a vehicle in the form of an aqueous urea solution that is dosed as needed via an injector upstream of the catalyst according to the invention.

The present invention accordingly also relates to a system for purifying exhaust gas from lean-operated internal combustion engines, characterized in that it comprises a catalyst according to the invention with an SCR-active coating as well as an injector for aqueous urea solution, wherein the injector is located before the first end of the catalyst substrate.

It is, for example, known from SAE-2001-01-3625 that the SCR reaction with ammonia occurs faster when the nitrogen oxides are present in a 1:1 mixture consisting of nitrogen monoxide and nitrogen dioxide, or in any case approximate this ratio. Since the exhaust gas from lean-operated internal combustion engines generally has an excess of nitrogen monoxide in comparison to nitrogen dioxide, the document proposes increasing the portion of nitrogen dioxide with the assistance of an oxidation catalyst that is arranged upstream of the SCR catalyst.

One embodiment of the system according to the invention for purifying exhaust gas from lean-operated internal combustion engines accordingly comprises—in the direction of flow of the exhaust gas—an oxidation catalyst, an injector for aqueous urea solution, and a catalyst according to the invention with SCR-active coating, wherein the injector is located before the first end of the catalyst substrate.

In embodiments of the present invention, platinum on a carrier material is used as the oxidation catalyst.

All of the materials familiar to a person skilled in the art for this purpose are possible as the carrier material for the platinum. They have a BET surface of 30 to 250 m²/g, preferably of 100 to 200 m²/g (determined according to DIN 66132), and are in particular aluminum oxide, silicon oxide, magnesium oxide, titanium oxide, zirconium oxide, cerium oxide as well as mixtures or mixed oxides of at least two of these oxides.

Aluminum oxide and aluminum/silicon mixed oxides are preferred. If aluminum oxide is used, it is particularly preferably stabilized, e.g., with lanthanum oxide.

The oxidation catalyst is normally located on a flow-through substrate, in particular a flow-through substrate consisting of cordierite.

### EXAMPLE 1

a) Proceeding from one end, a conventional wall flow filter consisting of cordierite was coated on 50% of its length by means of a conventional dip method with a wash coat that contains a zeolite of the chabazite structure type exchanged with 4.0% by weight copper. The SAR value of the zeolite was 30. Then, the filter was dried at 120° C.

b) Proceeding from its other end, the wall flow filter obtained in step a) was also coated in a second step on 50% of its length by means of a conventional dip method with a wash coat that contains a zeolite of the levyne structure type exchanged with 3.5% by weight copper. The SAR value of the zeolite was 31. This was followed by drying and calcination for 2 hours at 500° C.

c) The wall flow filter obtained in this manner exhibits a very effective NOx conversion within a range of 250 to more than 550° C. in a dynamic SCR test in a model gas system, wherein the model gas first comes into contact with the copper levyne and then with the copper chabazite. In this case, the formation of N₂O remains within tolerable bounds over the entire temperature range.

### EXAMPLE 2

Example 1 was repeated with the difference that a conventional flow-through substrate consisting of cordierite was used instead of a conventional wall flow filter consisting of cordierite. Both the zeolite of the chabazite structure type exchanged with 4.0% by weight copper as well as the zeolite of the levyne structure type exchanged with 3.5% by weight copper were applied in an amount of 200 g/L substrate. In contrast to example 1, the zeolite of the levyne structure type has an SAR value of 30.

### COMPARATIVE EXAMPLE 1

Example 2 was repeated with the difference that 250 g/L of the zeolite of the chabazite structure type exchanged with 4.0% by weight copper was applied in step a), and the zeolite of the chabazite structure type exchanged with 4.0% by weight copper that was already used in step a) was applied in an amount of 150 g/L substrate in step b).

NOx Conversion Test

a) The catalysts according to example 2 and comparative example 1 were aged hydrothermally for 16 hours at 800° C.

b) The NOx conversion of the aged catalyst as well as the formation of N₂O depending on the temperature before the catalyst were determined in a model gas reactor in a so-called NOx conversion test. This test consists of a test procedure that comprises a pretreatment and a test cycle that is run through for various target temperatures. The applied gas mixtures are noted in the following table.

Test Procedure:

1. Preconditioning at 600° C. in N₂ for 10 min

2. Test cycle repeated for the target temperatures
a. Target temperature approached in gas mixture 1
b. Addition of NOx (gas mixture 2)
c. Addition of NH₃ (gas mixture 3), wait until NH₃ exceeds >20 ppm, or a maximum of 30 min. in duration
d. Temperature-programmed desorption up to 500° C. (gas mixture 3)

TABLE
Gas mixtures of the NOx conversion test.

| | | | |
|---|---|---|---|
| Gas mixture | 1 | 2 | 3 |

| | | | |
|---|---|---|---|
| N₂ | Balance | Balance | Balance |
| O₂ | 10 percent | 10 percent | 10 percent |
| | by volume | by volume | by volume |

| | | | | | | |
|---|---|---|---|---|---|---|
| NOx | 0 | ppm | 500 | ppm | 500 | ppm |
| NO₂ | 0 | ppm | 0 | ppm | 0 | ppm |
| NH₃ | 0 | ppm | 0 | ppm | 750 | ppm |
| CO | 350 | ppm | 350 | ppm | 350 | ppm |
| C₃H₆ | 100 | ppm | 100 | ppm | 100 | ppm |

| | | | |
|---|---|---|---|
| H₂O | 5 percent | 5 percent | 5 percent |
| | by volume | by volume | by volume |

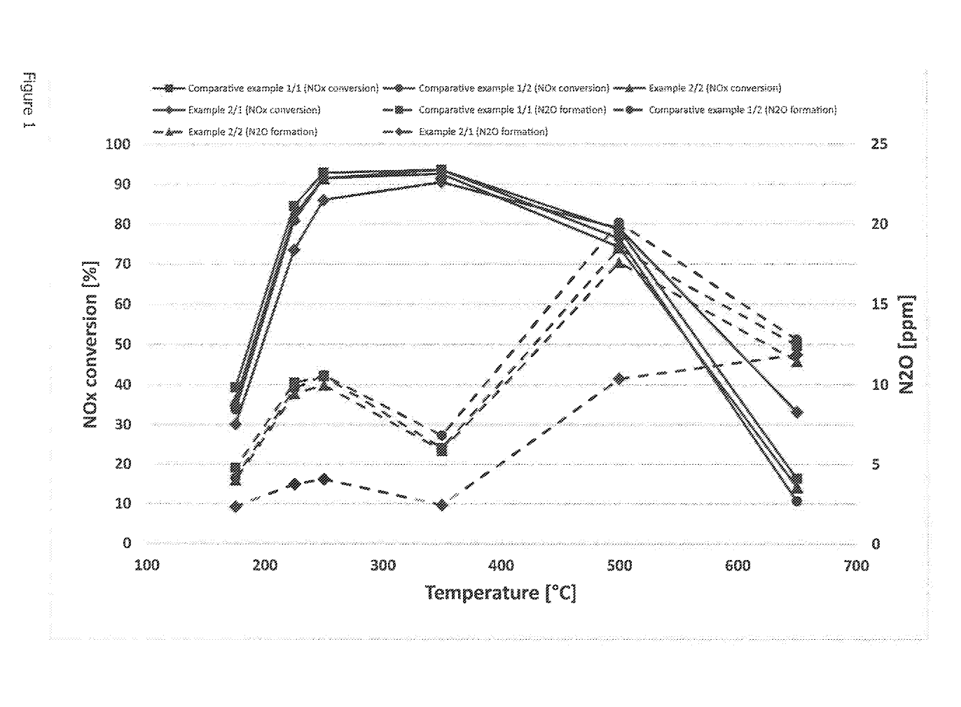

For each temperature below 500° C. (space velocity of 60 k h⁻¹ in each case), the conversion with an NH₃ slip of 20 ppm was determined for test procedure range 2c. For each temperature point above 500° C. (space velocity of 100 k h⁻¹), the conversion in a state of equilibrium was determined in test temperature range 2c. The N₂O concentration was determined at all of the temperature points by means of FT-IR. An application as shown in FIG. 1 results from the application of the NOx conversion as well as the N₂O concentration for the different temperature points.

The catalyst according to example 2 was once tested such that the model gas first came into contact with the copper levyne and then with the copper chabazite. This measurement is designated as example 2/1 in FIG. 1.

In addition, the catalyst according to example 2 was also tested “in reverse” so that the model gas first came into contact with the copper chabazite and then with the copper levyne. This measurement is designated as example 2/2 in FIG. 1.

The same procedure was also used for the catalyst according to comparative example 1. In FIG. 1, the measurement in which the load of copper chabazite of 250 g/L first came into contact with the modeled gas is designated comparative example 1/1 and the measurement in which the load with copper chabazite of 150 g/L first came into contact with the model gas is designated comparative example 1/2.

In FIG. 1, it can be seen that the NOx conversions of the catalysts according to example 2 and comparative example 1 (see the solid lines) do not differ very much independently of the side where the model gas entered the respective catalyst. It is however very clear that the catalyst according to example 2 forms significantly less nitrous oxide (see the dashed lines) over the entire temperature range when the model gas first comes into contact with copper levyne and then with copper chabazite (example 2/1).

1. A catalyst that comprises a catalyst substrate of length L and two SCR-catalytically active materials A and B that differ from each other,
wherein the SCR-catalytically active material A comprises a zeolite of the levyne structure type that contains ion-exchanged iron and/or copper, and the SCR-catalytically active material B comprises a zeolite of the chabazite structure type that contains ion-exchanged iron and/or copper, wherein
(i) the SCR-catalytically active materials A and B are present in the form of two material zones A and B, wherein material zone A proceeding from the first end of the catalyst substrate extends at least over a part of the length L and material zone B proceeding from the second end of the catalyst substrate extends at least over part of the length L,
or wherein
(ii) the catalyst substrate is formed from the SCR-catalytically active material A and a matrix component, and the SCR-catalytically active material B extends in the form of a material zone B at least over part of the length L of the catalyst substrate,
or wherein
(iii) the catalyst substrate is formed from the SCR-catalytically active material B and a matrix component, and the SCR-catalytically active material A extends in the form of a material zone A at least over part of the length L of the catalyst substrate.

2. The catalyst according to claim 1, characterized in that the zeolite of the chabazite structure type has an SAR value of 6 to 40.

3. The catalyst according to claim 1, characterized in that the zeolite of the levyne structure type has an SAR value greater than 15.

4. The catalyst according to claim 1, characterized in that both the zeolite of the chabazite structure type and the zeolite of the levyne structure type contain ion-exchanged copper.

5. The catalyst according to claim 4, characterized in that the copper in the zeolite of the chabazite structure type and in the zeolite of the levyne structure type is independently present in amounts of 0.2 to 6% by weight in each case, calculated as CuO and in relation to the overall weight of the exchanged zeolite.

6. The catalyst according to claim 1, characterized in that the atomic ratios of copper to aluminum in the zeolite of the chabazite structure type and in the zeolite of the levyne structure type are independently of each other 0.25 to 0.6.

7. The catalyst according to claim 1, characterized in that 20 to 80% by weight of the catalytically active material is in material zone B.

8. The catalyst according to claim 1, characterized in that material zone A extends over the entire length L of the catalyst substrate and material zone B proceeding from the second end of the catalyst substrate extends over 10 to 80% of its length L.

9. The catalyst according to claim 1, characterized in that material zone A proceeding from the first end of the catalyst substrate extends over 20 to 90% of its length L and material zone B proceeding from the second end of the catalyst substrate extends over 10 to 70% of its length L.

10. The catalyst according to claim 1, characterized in that material zone A proceeding from the first end of the catalyst substrate extends over 20 to 100% of its length L and material zone B extends over the entire length of the catalyst substrate.

11. The catalyst according to claim 1, characterized in that the catalyst substrate is a wall flow filter and the channels that are open at the first end of the wall flow filter and closed at the second end are coated with material zone A and the channels that are closed at the first end of the wall flow filter and open at the second end are coated with material zone B.

12. A method for purifying exhaust gas from lean-operated internal combustion engines, characterized in that the exhaust gas is conducted over a catalyst according to claim 1, wherein material zone A comes into contact with the exhaust gas to be purified before material zone B.

13. A system for purifying exhaust gas from lean-operated internal combustion engines, characterized in that it comprises a catalyst according to claim 1 as well as an injector for aqueous urea solution, wherein the injector is located before the first end of the catalyst substrate.

14. A system for purifying exhaust gas from lean-operated internal combustion engines comprising: in the direction of flow of the exhaust gas, an oxidation catalyst, an injector for aqueous urea solution and a catalyst according to claim 1, wherein the injector is located before the first end of the catalyst substrate.

15. The system according to claim 14, characterized in that platinum on a carrier material is used as the oxidation catalyst.
